(19) United States
(12) Patent Application Publication
(10) Pub. No.: US 2017/0161626 A1
(43) Pub. Date: Jun. 8, 2017

(54) Testing Procedures for Sequential Processes with Delayed Observations

(71) Applicant: International Business Machines Corporation, Armonk, NY (US)

(72) Inventors: Mary E. Helander, North White Plains, NY (US); Janusz Marecki, New York, NY (US); Ramesh Natarajan, Pleasantville, NY (US); Bonnie K. Ray, Nyack, NY (US)

(21) Appl. No.: 14/501,673

(22) Filed: Sep. 30, 2014

Related U.S. Application Data
(60) Provisional application No. 62/036,417, filed on Aug. 12, 2014.

(51) Int. Cl. G06N 7/00

(52) U.S. Cl. CPC G06N 7/005

(57) ABSTRACT

A method for determining a policy that considers observations delayed at runtime is disclosed. The method includes constructing a model of a stochastic decision process that receives delayed observations at run time, wherein the stochastic decision process is executed by an agent, finding an agent policy according to a measure of an expected total reward of a plurality of agent actions within the stochastic decision process over a given time horizon, and bounding an error of the agent policy according to an observation delay of the received delayed observations.

### CROSS-REFERENCE TO RELATED APPLICATIONS

This application claims the benefit of U.S. Provisional Patent Application No. 62/036,417 filed on Aug. 12, 2014, the complete disclosure of which is expressly incorporated herein by reference in its entirety for all purposes.

### GOVERNMENT LICENSE RIGHTS

This invention was made with Government support under Contract No.: W911NF-06-3-0001 awarded Army Research Office (ARO). The Government has certain rights in this invention.

### BACKGROUND

The present disclosure relates to methods for planning in uncertain conditions, and more particularly to solving Delayed observation Partially Observable Markov Decision Processes (D-POMDPs).

Recently, there has been in increase in interest in autonomous agents deployed in domains ranging from automated trading, traffic control, disaster rescue and space exploration. Delayed observation reasoning is particularly relevant in providing real time decisions based on traffic congestion/incident information, in making decisions on new products before receiving the market response to a new product, etc. Similarly in therapy planning, in some cases, a patient's treatment has to continue even if patient's response to a medicine is not observed immediately. Delays in receiving such information can be due to data fusion, computation, transmission and physical limitations of the underlying process.

Attempts to solve problems having delayed observations and delayed reward feedback have been designed to provide sufficient statistic and theoretical guarantees on the solution quality for static and randomized delays. Although the theoretical properties are important, an approach based on using sufficient statistic is not scalable.

### BRIEF SUMMARY

According to an exemplary embodiment of the present invention, a method for determining a policy that considers observations delayed at runtime is disclosed. The method includes constructing a model of a stochastic decision process that receives delayed observations at run time, wherein the stochastic decision process is executed by an agent, finding an agent policy according to a measure of an expected total reward of a plurality of agent actions within the stochastic decision process over a given time horizon, and bounding an error of the agent policy according to an observation delay of the received delayed observations.

### BRIEF DESCRIPTION OF THE SEVERAL VIEWS OF THE DRAWINGS

Preferred embodiments of the present invention will be described below in more detail, with reference to the accompanying drawings:

FIG. 1 shows an exemplary method for online policy modification according to an exemplary embodiment of the present invention;

FIG. 2 is a graph of a case where online policy modification provides improvement (e.g., the Tiger problem) according to an exemplary embodiment of the present invention;

FIG. 3 shows a graph of a case where online policy modification may or may not provide improvement (e.g., an information transfer problem) according to an exemplary embodiment of the present invention;

FIG. 4 is a flow diagram of a method for online policy modification according to an exemplary embodiment of the present invention; and

FIG. 5 is a diagram of a computer system configured for online policy modification according to an exemplary embodiment of the present invention.

### DETAILED DESCRIPTION

According to an exemplary embodiment of the present invention, methods are described for a parameterized approximation for solving Delayed observation Partially Observable Markov Decision Processes (D-POMDPs) with a desired accuracy. A policy execution technique is described that adjusts an agent policy corresponding to delayed observations at run-time for improved performance.

Exemplary embodiments of the present invention are applicable to various fields, for example, food safety testing (e.g., testing for pathogens) and communications, and more generally to Markov decision processes with delayed state observations. In the field of food safety testing sequential testing can be inaccurate, test results arrive with delays and a testing period is finite. In the field of communications, within dynamic environments, communication messages can be lost or arrive with delays.

A Partially Observable Markov Decision Process (POMDP) describes a case wherein an agent operates in an environment where the outcomes of agent actions are stochastic and the state of the process is only partially observable to the agent. A POMDP is a tuple [symbol] S, A, Ω, P, R, O [symbol] , where S is the set of process states, A is the set of agent actions and Ω is the set of agent observations. P(s′|a,s) is the probability that the process transitions from state sεS to state s′εS when the agent executes action aεA, while O(ω|a, s′) is the probability that the observation that reaches the agent is wεΩ. R(s,a) is the immediate reward that the agent receives when it executes action a in state s. Rewards can include a cost of a given action, in addition to any benefit or penalty associated with the action.

A POMDP policy π:B×TεA can be defined as a mapping from agent belief states bεB at decision epochs tεT to agent actions aεA. An agent belief state b=(b(s))_{sεS} is the agent belief about the current state of the system. To solve a POMDP, a policy π* is found that increases (e.g., maximizes) the expected total reward of the agent actions (=sum of its immediate rewards) over a given time horizon T.

According to an exemplary embodiment of the present invention, a D-POMDP model allows for modeling of delayed observations. A D-POMDP is a tuple [symbol] S, A, Ω, P, R, O, χ [symbol] , wherein χ is a set of random variables χ_{s,a}(k) that specify the probability that an observation is delayed by k decision epochs, when action a is executed in state s. An example of χ_{s,a} would be the discrete distribution (0.5, 0.3, 0.2), where 0.5 represents no delay, 0.3 represents one time step delay and 0.2 represents two time step delay in receiving the observation in state s on executing action a. D-POMDPs extend POMDPs by modeling the observations that are delayed and by allowing for actions to be executed prior to receiving these delayed observations. In essence, if the agent receives an observation immediately after executing an action, D-POMDPs behave exactly as POMDPs. In a case where an observation does not reach the agent immediately, D-POMDPs behave differently from POMDPs. Rather than having to wait for an observation to arrive, a D-POMDP agent can resume the execution of its policy prior to receiving the observation. A D-POMDP agent can balance the trade off of acting prematurely (without the information provided by the observations that have not yet arrived) versus executing stop-gap (waiting) actions.

Quality bounded and efficient solutions for D-POMDPs are described herein. According to an exemplary embodiment of the present invention, a D-POMDP can be solved by converting the D-POMDP to an approximately equivalent POMDP and employing a POMDP solver to solve the obtained POMDP. A parameterized approach can be used for making the conversion from D-POMDP to its approximately equivalent POMDP. The level of approximation is controlled by an input parameter, D, which represents the number of delay steps considered in a planning process. The extended POMDP obtained from the D-POMDP is defined as the tuple [symbol] S, A, Ω, P, R, O [symbol] where S is the set of extended states and Ω is a set of extended observations that the agent receives upon executing its actions in extended states. P, R, O are the extended transition, reward and observations functions, respectively. To define these elements of the extended POMDP tuple, the concepts of extended observations, delayed observations, and hypothesis about delayed observations are formalized.

According to an exemplary embodiment of the present invention, an extended observation a vector ω̅=(ω̅[0], ω̅[1], . . . , ω̅[D])ω=(ω[0], ω[1], . . . , ω[D]), where ω̅[d]εΩ∪{Ø} is a delayed observation for an action executed d decision epochs ago. Delayed observation ω̅[d]εωεΩ only if observation ω for an action executed d decision epochs ago has just arrived (in the current decision epoch); Otherwise w̅[d]=Ø.

For example, an agent in a “Tiger Domain” can receive an extended observation ω=(O_{TigerLeft}, Ø, O_{TigerRight}) wherein O_{TigerRight} is a consequence of action a_{Listen} executed two decision epochs ago.

According to an exemplary embodiment of the present invention, a hypothesis about a delayed observation for an action executed d decision epochs ago is a pair h[d]ε{(ω⁻,X),(ω⁺,X),(Ø,Ø)|ωεΩ; Xεχ} h[d]ε{(ω−, X), (ω+, X), (,)|ωεΩ; XεX}. Hypothesis h[d]ε(ω⁻,X) states that a delayed observation for an action executed d decision epochs ago is ωεΩ and that ω is yet to arrive, with a total delay sampled from probability distribution Xεχ. Hypothesis h[d]=(ω+, X) states that a delayed observation for an action executed d decision epochs ago was ωεΩ, that ω has just arrived (in the current decision epoch), and that its delay was sampled from probability distribution Xεχ. Finally, hypothesis h[d]=(Ø,Ø) states that an observation for an action executed d decision epochs ago had arrived in the past (in previous decision epochs). In the following, h[d][1] and h[d][2] are used to denote the observation and random variable components of h[d], that is, h[d]≡(h[d][1],h[d][2]).

For example, an agent in a “Tiger Domain” maintains a hypothesis h[2]=(o_{TigerRight}⁻,χ) whenever it believes that action a_{Listen} executed two decision epochs ago resulted in observation O_{TigerRight} that is yet to arrive, with a delay sampled from a distribution χ.

According to an exemplary embodiment of the present invention, an extended hypothesis about the delayed observations for actions executed 1, 2, . . . , D decision epochs ago is a vector h=(h[1], h[2], . . . , h[D]) where h[d] is a hypothesis about a delayed observation for an action executed d decision epochs ago. The set of all possible extended hypotheses is denoted by H.

In each decision epoch, the converted POMDP occupies an extended state s̅=(s,h)εS̅ where sεS is the state of the underlying Markov process and h is an extended hypothesis about the delayed observations. From there, a D-POMDP agent executes an action, a, it causes the underlying Markov process to transition from state sεS to state s′εS with probability P(s′|s,a), it does provide the agent with an immediate payoff R̅(s̅,a):=R(s,a) and it does generate a new delayed observation ωεΩ in the current decision epoch, with probability O(ω|a,s′).

For example, the converted POMDP for a “Tiger Domain” can occupy an extended state s̅=(s_{TigerLeft},(Ø,Ø),(o_{TigerRight}⁻,χ)). An agent who believes that the converted POMDP is in s̅ thus believes that the tiger is behind the left door, that the observation for an action executed one decision epoch ago has already arrived and that action a_{Listen} executed two decision epochs ago resulted in observation o_{TigerRight} that is yet to arrive, with a delay sampled from a distribution χ.

To construct the functions P, R and O that describe the behavior of a converted POMDP: Let s̅=(s,h)=(s,(h[1], h[2], . . . , h[D]))εS̅ be the current extended state and a be an action that the agent executes in s̅. The converted POMDP then transitions to an extended state s̅′=(s′,h′)=(s′,(h′[1], h′[2], . . . , h′[D]))εS̅ with probability P̅(s̅′|s̅,a). Intuitively, when a is executed, the underlying Markov process transitions from state s to state s′ while each hypothesis h[d] of the initial extended hypothesis vector h is either shifted by one position to the right (if delayed observation h[d][1] does not arrive) or becomes (ω+, X) and later (Ø,Ø) (if delayed observation h[d][1] arrives). Formally:

$$\overline{P} ( {\overline{s}}^{′} \vert \overline{s} , a ) = P ( {s}^{′} \vert s , a ) \cdot O ( {h}^{′} [ 1 ] [ 1 ] \vert a , {s}^{′} ) \cdot {\prod }_{d = 1}^{D} \{ \begin{matrix}Pb ( \{ {h}^{′} [ d ] [ 2 ] > d \} \vert \{ {h}^{′} [ d ] [ 2 ] \geq d \} ) & case 1 \\ Pb ( \{ {h}^{′} [ d ] [ 2 ] = d \} \vert \{ {h}^{′} [ d ] [ 2 ] \geq d \} ) & case 2 \\ 1 & case 3 \\ 1 & case 4 \\ 0 & else\end{matrix}$$

case 1: Is used when observation ω for action a executed d decision epochs ago has not yet arrived, i.e., if h[d−1][1]=h′[d−1][1]=ω⁻ and obviously h[d−1][2]=h′[d][2].

case 2: Is used when observation ω for action a executed d decision epochs ago just arrived, i.e., if h[d−1][1]=ω⁻,h[d][1]=ω⁺ and obviously h[d−1][2]=h′[d][2].

case 3: Is used when observation ω for action a executed d decision epochs ago arrived in the previous decision epoch, i.e., if h[d−1][1]=ω⁺ and h[d]=(Ø,Ø).

case 4: Is used when an observation for action a executed d decision epochs ago had either arrived before the previous decision epochs or has not arrived and will not arrive.

In addition, for the special case of d=0, we define:

$$h [ 0 ] := ( {h}^{′} [ 1 ] [ 1 ] , {X}_{s , a} )$$

$$O ( ∅ \vert ∅ , {s}^{′} ) := 1$$

$$P ( {s}^{′} \vert s , ∅ ) := \{ \begin{matrix}1 & if s = {s}^{′} \\ 0 & otherwise\end{matrix}$$

The probabilities Pb({h′[d][2]>d} {h′[d][2]≧d}) and Pb({h′[d][2]>d}|{h′[d][2]≧d}) are:

$$Pb ( \{ {h}^{′} [ d ] [ 2 ] = d \} \vert \{ {h}^{′} [ d ] [ 2 ] \geq d \} ) = \frac{Pb ( {h}^{′} [ d ] [ 2 ] = d )}{{\sum }_{{d}^{′} = d}^{∞} Pb ( {h}^{′} [ d ] [ 2 ] = {d}^{′} )}$$

$$Pb ( \{ {h}^{′} [ d ] [ 2 ] > d \} \vert \{ {h}^{′} [ d ] [ 2 ] \geq d \} ) = 1 - Pb ( \{ {h}^{′} [ d ] [ 2 ] = d \} \vert \{ {h}^{′} [ d ] [ 2 ] \geq d \} )$$

When the converted POMDP transitions to [symbol] =(s′,h′)=(s′,(h′[1], h′[2], . . . , h′[D])) as a result of the execution of a, the agent receives an extended observation. The probability that this extended observation is ω̅=(ω̅[0], ω̅[1], . . . , ω̅[D]) is calculated from:

$$\overline{O} ( \overline{ω} \vert a , {\overline{s}}^{′} ) = {\prod }_{d = 1}^{D} \{ \begin{matrix}Pb ( \{ {h}^{′} [ d ] [ 2 ] > d \} \vert \{ {h}^{′} [ d ] [ 2 ] \geq d \} ) & case 1 \\ Pb ( \{ {h}^{′} [ d ] [ 2 ] = d \} \vert \{ {h}^{′} [ d ] [ 2 ] \geq d \} ) & case 2 \\ 1 & case 3 \\ 0 & else\end{matrix}$$

case 1: Is used when the agent had been waiting for a delayed observation ω for an action that it had executed d decision epochs ago but this delayed observation did not arrive in the extended observation ω̅ that it received in the current decision epoch, i.e., h′[d][1]=ω⁻ and ω̅[d−1][1]=Ø.

case 2: Is used when the agent had been waiting for a delayed observation ω for an action that it had executed d decision epochs ago and this delayed observation did arrive in the extended observation ω̅ that it received in the current decision epoch, i.e., h′[d][1]=ω⁺ and ω̅[d−1]=ω.

case 3: Is used when the agent had not been waiting for a delayed observation for an action that it had executed d decision epochs ago and this delayed observation did not arrive in the extended observation ω̅ that it received in the current decision epoch, i.e., h′[d][1]=Ø and ω̅[d−1]=Ø. In all other cases, the probability that the agent receives ω̅ is zero.

The extended POMDP thus obtained can be solved using any existing POMDP solvers.

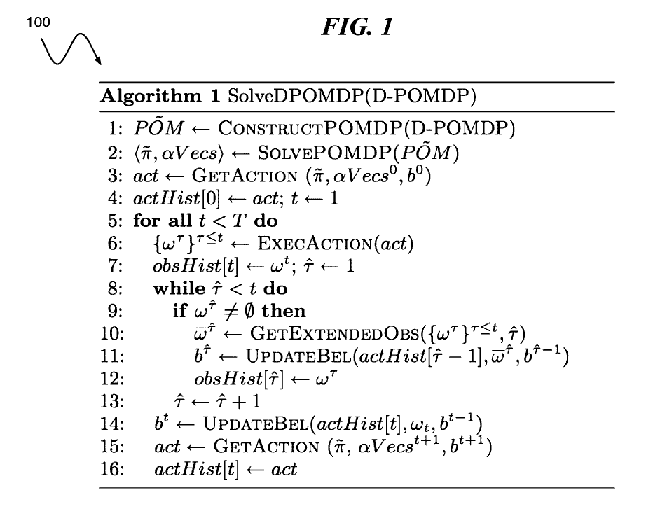

According to an exemplary embodiment of the present invention, an online policy modification is exemplified by FIG. 1. That is, FIG. 1 shows an exemplary technique for modifying the policy of a converted POMDP during execution. Typically, the policy execution in a POMDP is initiated by executing the action at the root of the policy tree, selecting and executing the next action based on the received observation and so on. This type of policy execution suffices in normal POMDPs. According to an exemplary embodiment of the present invention, in extending POMDPs corresponding to D-POMDPs, the policy execution is improved. During policy execution, the beliefs that an agent has can be outdated (e.g., due to not updating the belief once delayed observations are received). According to an exemplary embodiment of the present invention, the belief state is updated in an efficient manner, for example, updating the beliefs if and when the delayed observations are received.

Once the estimation of the current extended belief state is refined by these delayed observations from more than D decision epochs ago, the action corresponding to the new belief state is determined from the value vectors. The original set of value vectors (policy) would be still applicable, because belief state is a sufficient statistic and the policy is defined over the entire belief space.

Referring to FIG. 1, at runtime a history of observations (a vector of size T with elements ωεΩ∪{Ø}) and a history of actions executed in all the past decision epochs are is maintained (history of actions is initiated in line 4 and later updated in line 16; history of observations is updated in lines 7 and 12). These histories can be recalled at later decision epochs. When a delayed observation is received at the current decision epoch (vector of received delayed observations is read at line 6), the earlier belief states are revisited and updated accordingly using the delayed observation and the stored history of actions and observations (see lines 8-13). At the current decision epoch, the belief state is updated based on either the current epoch observation, if it is immediately observed, or based on Ø (see line 14). Using this updated belief state, its corresponding action is extracted (see line 15) and executed in the next decision epoch (see line 5).

According to an exemplary embodiment of the present invention, a method 100 according to FIG. 1 includes a bound on error due to a conversion procedure.

To solve a decision problem involving delayed observations exactly, one must use an optimal POMDP solver and conversion from D-POMDP to POMDP must be done with D≧sup{d|Pb[X=d]>0, Xεχ} to prevent the delayed observations from ever being discarded. However, to trade-off optimality for speed, one can use a smaller D, resulting in a possible degradation in solution quality. The error in the expected value of the POMDP (obtained from D-POMDP) policy when such D is chosen, that is, when D is less than a maximum delay Δ of the delayed observations.

A D-POMDP constructed for a given D. For any s, s′δS, aεA and hεH it then holds that:

$$\vert P ( {s}^{′} \vert s , a ) - {\sum }_{{h}^{′} ∈ H} P ( ( {s}^{′} , {h}^{′} ) \vert ( s , h ) , a ) \vert \leq Pb [ h [ D ] [ 2 ] > D ] . \qquad ( 1 )$$

This proposition (i.e., Eq. (1)) bounds the error in P by estimating the true transition probability in the underlying Markov process. This is then used to determine the error bound on value as follows:

Using Eq. 1, the error in expected value of the POMDP (obtained from D-POMDP) policy for a given D is then bounded by:

$${\sum }_{t = 1}^{T} ε \cdot {( 1 + ε )}^{t - 1} \cdot {R}_{max} ( {( 1 + ε )}^{T} - 1 ) \cdot {R}_{max} . \\ where \\ {R}_{max} := {max}_{s ∈ S , a ∈ A} \vert R ( s , a ) \vert \\ ∈ := {max}_{X ∈ χ} \{ Pb [ X > D ] \} . \qquad ( 2 )$$

According to an embodiment of the present invention, improvement in solution quality is achieved through online policy modification. One objective of online policy modification is to keep the belief distribution up to date based on the observations, irrespective of when they are received. In certain specific situations it is possible to guarantee a definite improvement in value.

Improvement in solution quality can be demonstrated in cases where: (a) a belief state corresponding to a delayed observation has more entropy than a belief state corresponding to any normal observation; and (b) for some characteristics of the value function, value decreases when the entropy of the belief state increases. Consider the following:

Corresponding to a belief state b and action a, denote by b^{ω} the belief state on executing action a and observing ω and by b^{φ} the belief state on executing action a and an observation getting delayed (represented as observation φ). In this context, if

O(\tilde{s},a,φ)=O^{φ},∀\tilde{s}εS

For some constant O^{φ} then

$$Entropy ( {b}^{ω} ) \leq Entropy ( {b}^{φ} )$$

$$or \\ - {\sum }_{s} ( {b}^{ω} ( s ) ln ( {b}^{ω} ( s ) ) \leq - {\sum }_{s} {b}^{φ} ( s ) ln ( {b}^{φ} ( s ) )$$

For any two belief points b₁ and b₂ in the belief space, if

$${\sum }_{s} {b}_{1} ( s ) ln ( {b}_{1} ( s ) ) \geq {\sum }_{s} {b}_{2} ( s ) ln ( {b}_{2} ( s ) ) ⇒ ( {b}_{1} ) \geq ( {b}_{2} ) \qquad ( 3 )$$

then the online policy modification improves on the value provided by the offline policy.

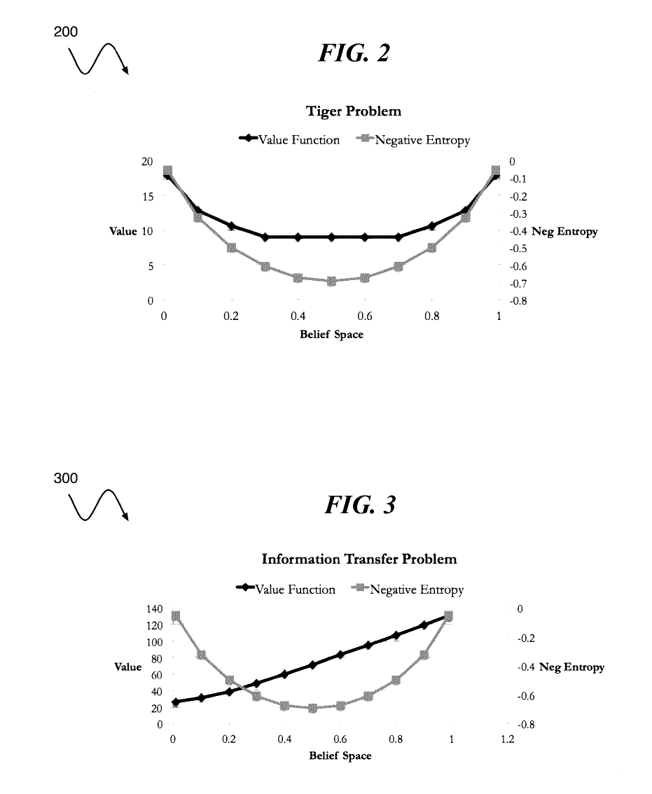

To graphically illustrate the improvement demonstrated in connection with Eq. (3), FIG. 2 shows a case 200 where online policy modification will definitely provide improvement (Tiger problem) and FIG. 3 shows a case 300 where it may or may not provide improvement (information transfer problem).

Referring to the complexity of online policy modification, for a given D, the number of extended observations is |Ō|=|Ω∪{Ø}|^{D} and the number of extended states is |S̅|=|S×H|=|S|·|H|=|S|·(2·|Ω∥χ|)^{D}, while in practice these numbers can be significantly smaller, for not all the technically valid extended states are reachable from the starting state and only a fraction of all the valid extended observations are plausible upon executing an action in an extended state. As for the number of runtime policy adjustments at execution time, it can be bounded in terms of the planning horizon and maximal observation delay as shown below.

Given a D-POMDP, wherein a maximum delay for any observation is Δ:=sup{d|Pb[X=d]>0, Xεχ} and the time horizon is T, a maximum number of belief updates, N_{b} is given by:

$${N}_{b} = \frac{Δ \cdot ( Δ + 1 )}{2} + ( T - Δ ) \cdot Δ .$$

It should be understood that the use of term maximum herein denotes a value, and that the value can vary depending on a method used for determining the same. As such, the term maximum may not refer to an absolute maximum and can instead refer to a value determined using a described method.

As can be seen in lines 9 and 10 of FIG. 1, an observation delayed by t time steps leads to t extra belief updates, one update per each time step that the observation is delayed for. Therefore, in an extreme (e.g., worst) case, every observation is delayed by a maximum possible delay Δ. To determine a maximum total number of belief updates, the process of counting the extra belief updates is now described at each time step 1 through T.

Updates at time step 1: In an extreme case, the observation to be received at time step 1 is received at time step Δ. The said observation thus introduces just one extra belief update at time step 1.

Updates at time step 2: There are at most two extra belief updates introduced at time step 2: one from an observation generated at time step 1 but received at time step Δ and another from an observation generated at time step 2 but received at time step Δ+1.

Updates at time step t≦Δ: There are at most t extra belief updates introduced at time step t: one from each observation generated at time step t′ but received at time step Δ+t′, for 1≦t′≦t.

Updates at time step Δ≦t′≦T: There are at most Δ extra belief updates introduced at time step t: one from each observation generated at time step t′ but received at time step min{Δ+t′,T}, for t−Δ<t′≦t.

Adding a maximum numbers of extra belief updates introduced at time steps 1 through T, a maximum total number of belief updates is obtained as:

$${N}_{b} = \frac{Δ \cdot ( Δ + 1 )}{2} + ( T - Δ ) \cdot Δ .$$

It should be understood that the methodologies of embodiments of the invention may be particularly well-suited for planning in uncertain conditions.

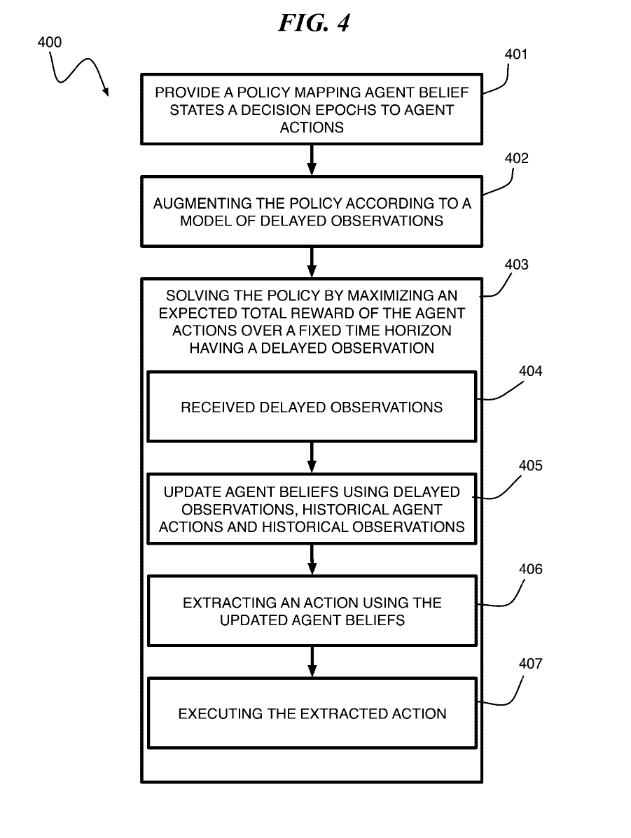

By way of recapitulation, according to an exemplary embodiment of the present invention, a decision engine (e.g., embodied as a computer system) performs a method (400) for adjusting a policy corresponding to delayed observations at runtime is shown in FIG. 4 and includes providing a policy mapping from agent belief states at decision epochs to agent actions (401), augmenting the policy according to a model of delayed observations (402), and solving the policy by maximizing an expected total reward of the agent actions over a fixed time horizon having a delaying observation (403).

The process of solving the policy (403) further includes receiving delayed observations (404), updating agent beliefs using the delayed observations, historical agent actions and historical observations (405), extracting an action using the updated agent beliefs (406) and executing the extracted action (407). At block 407, the agent can be instructed to execute the extracted action.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a system for adjusting a policy corresponding to delayed observations. According to an embodiment of the present invention, the system is computer executing a policy and monitoring agent actions. Further, a computer program product can include a tangible computer-readable recordable storage medium with code adapted to be executed to carry out one or more method steps described herein, including the provision of the system with the distinct software modules.

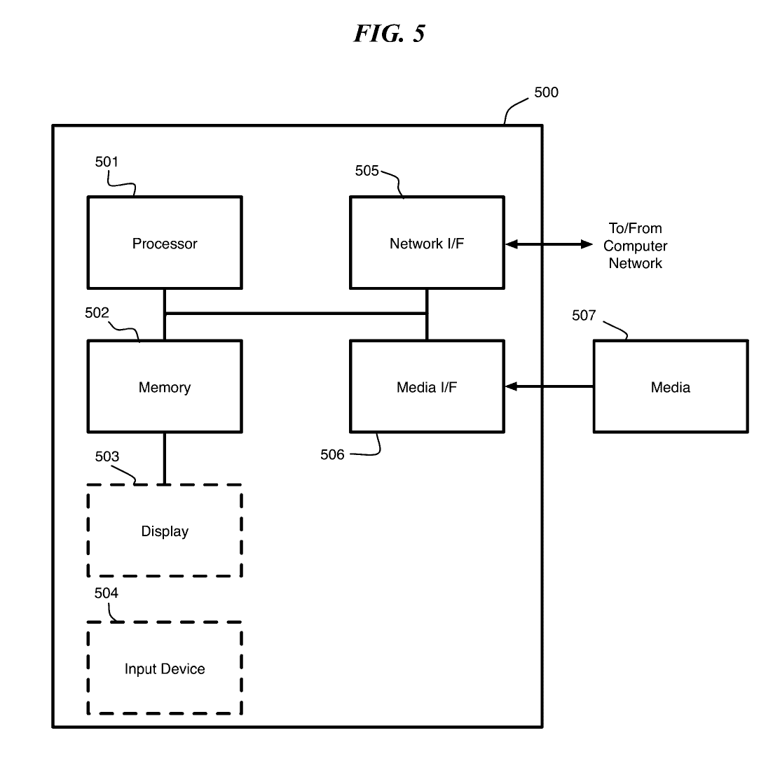

Referring to FIG. 5; FIG. 5 is a block diagram depicting an exemplary computer system for adjusting a policy corresponding to delayed observations according to an embodiment of the present invention. The computer system shown in FIG. 5 includes a processor 501, memory 502, display 503, input device 504 (e.g., keyboard), a network interface (I/F) 505, a media IF 506, and media 507, such as a signal source, e.g., camera, Hard Drive (HD), external memory device, etc.

In different applications, some of the components shown in FIG. 5 can be omitted. The whole system shown in FIG. 5 is controlled by computer readable instructions, which are generally stored in the media 507. The software can be downloaded from a network (not shown in the figures), stored in the media 507. Alternatively, software downloaded from a network can be loaded into the memory 502 and executed by the processor 501 so as to complete the function determined by the software.

The processor 501 may be configured to perform one or more methodologies described in the present disclosure, illustrative embodiments of which are shown in the above figures and described herein. Embodiments of the present invention can be implemented as a routine that is stored in memory 502 and executed by the processor 501 to process the signal from the media 507. As such, the computer system is a general-purpose computer system that becomes a specific purpose computer system when executing routines of the present disclosure.

Although the computer system described in FIG. 5 can support methods according to the present disclosure, this system is only one example of a computer system. Those skilled of the art should understand that other computer system designs can be used to implement embodiments of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method comprising:
constructing a model of a stochastic decision process that receives delayed observations at run time, wherein the stochastic decision process is executed by an agent;
finding an agent policy according to a measure of an expected total reward of a plurality of agent actions within the stochastic decision process over a given time horizon;
bounding an error of the agent policy according to an observation delay of the received delayed observations; and
offering a reward to the agent using the agent policy having the error bounded according to the observation delay of the received delayed observations.

2. The method of claim 1, wherein finding the agent policy comprises:
updating an agent belief state upon receiving each of the delayed observation; and
determining a next agent action according to the expected total reward of a remaining decision epoch given an updated agent belief state.

3. The method of claim 2, wherein the agent belief state is updated using the delayed observation, a history of observations at runtime and a history of agent actions at runtime.

4. The method of claim 2, wherein the agent executes the next agent action in a next decision epoch.

5. The method of claim 1, further comprising:
storing a history of observations at runtime;
storing a history of agent actions at runtime; and
recalling the history of observations at runtime and the history of agent actions at runtime to find the agent policy.

6. The method of claim 1, wherein the expected total reward comprises all rewards that the agent receives when a given agent action is executed in a current agent belief state.

7. The method of claim 1, wherein the observation delay of the received delayed observations is a maximum observation delay among the received delayed observations that is considered by the model.

8. A computer program product for planning in uncertain environments, the computer program product comprising a computer readable storage medium having program instructions embodied therewith, the program instructions executable by a processor to cause the processor to perform a method comprising:
receiving a model of a stochastic decision process that receives delayed observations at run time, wherein the stochastic decision process is executed by an agent;
finding an agent policy according to a measure of an expected total reward of a plurality of agent actions within the stochastic decision process over a given time horizon; and
bounding an error of the agent policy according to an observation delay of the received delayed observations.

9. The computer program product of claim 8, wherein finding the agent policy comprises:
updating an agent belief state upon receiving each of the delayed observation; and
determining a next agent action according to the expected total reward of a remaining decision epoch given an updated agent belief state.

10. The computer program product of claim 9, wherein the agent belief state is updated using the delayed observation, a history of observations at runtime and a history of agent actions at runtime.

11. The computer program product of claim 8, further comprising:
storing a history of observations at runtime;
storing a history of agent actions at runtime; and
recalling the history of observations at runtime and the history of agent actions at runtime to find the agent policy.

12. The computer program product of claim 8, wherein the expected total reward comprises all rewards that the agent receives when a given agent action is executed in a current agent belief state.

13. The computer program product of claim 8, wherein the observation delay of the received delayed observations is a maximum observation delay among the received delayed observations that is considered by the model.

14. A decision engine configured execute a stochastic decision process receiving delayed observations using an agent policy comprising:
a computer program product comprising a computer readable storage medium having program instructions embodied therewith, the program instructions executable by a processor to cause the decision engine to:
receive a model of the stochastic decision process that receives a plurality of delayed observations at run time, wherein the stochastic decision process is executed by an agent;
find an agent policy according to a measure of an expected total reward of a plurality of agent actions within the stochastic decision process over a given time horizon; and
bound an error of the agent policy according to an observation delay of the received delayed observations.

15. The decision engine of claim 14, wherein the agent policy comprises:
an agent belief state updated upon receiving each of the delayed observation; and
a next agent action extracted according to the expected total reward of a remaining decision epoch given the agent belief state.

16. The decision engine of claim 15, wherein the agent belief state is updated using the delayed observation, a history of observations at runtime and a history of agent actions at runtime.

17. The decision engine of claim 14, wherein the program instructions executable by the processor to cause the decision engine to:
store a history of observations at runtime;
store a history of agent actions at runtime; and
recall the history of observations at runtime and the history of agent actions at runtime to find the agent policy.

18. The decision engine of claim 14, wherein the expected total reward comprises all rewards that the agent receives when a given agent action is executed in a current agent belief state.

19. The decision engine of claim 14, wherein the observation delay of the received delayed observations is a maximum observation delay among the received delayed observations that is considered by the model.
